(19) United States
(12) Patent Application Publication
(10) Pub. No.: US 2011/0051003 A1
(43) Pub. Date: Mar. 3, 2011

(54) VIDEO IMAGE MOTION PROCESSING METHOD INTRODUCING GLOBAL FEATURE CLASSIFICATION AND IMPLEMENTATION DEVICE THEREOF

(75) Inventors: Jin Zhou, Beijing (CN); Qifeng Liu, Beijing (CN); Yu Deng, Beijing (CN); Jianxin Yan, Beijing (CN); Guoqing Xiong, Beijing (CN)

(73) Assignee: POWERLAYER MICROSYSTEMS HOLDING INC., George Town (KY)

(21) Appl. No.: 12/675,769

(22) PCT Filed: Aug. 27, 2008
(86) PCT No.: PCT/CN08/72171

§ 371 Date: Oct. 25, 2010

(30) Foreign Application Priority Data
Aug. 27, 2007 (CN) 200710147558.2

(51) Int. Cl. H04N 5/14

(52) U.S. Cl. 348/576; 348/E05.065

(57) ABSTRACT

The invention involves the technology of video digital image processing. With respect to the problem of larger error existed in the existing video image motion processing method, a video image motion processing method introducing global feature classification is provided. The video image motion processing method introducing global feature classification includes the following steps of: extracting local features of pixel points, including local motion features; extracting the global feature of an image; classifying the pixel points according to the obtained local features and the global feature; assigning correction parameters to the obtained types; correcting the local motion features by means of the obtained correction parameters. Another object of the invention is to provide a device for realizing the above video image motion processing method introducing global feature classification. Due to the introduction of the global feature of the video image to be processed for classifying the local motion features of pixel points, and the pertinent correction according to different types, the final local motion features obtained by using the technology scheme according to the present invention is more accurate.

### TECHNICAL FIELD

This invention belongs to digital image processing technology, especially involving with video digital image motion processing technology.

### TECHNICAL BACKGROUND

Currently, with respect to the video digital image motion processing, the processing is often focused on motion features and their changes at local area such as processed pixel points and/or some adjacent pixel points and etc., integration of processing results on local area motion features of all pixel points in an image composes a final processing result of the image. A motion adaptive algorithm, shown below, is an example to explain this common video image motion processing method.

Motion adaptive algorithm is a video digital image processing technology based on motion information, usually adopted in various image processing such as image interpolation, image de-interplacement, image de-noising, image enhancement and etc. The basic idea of the motion adaptive algorithm is to utilize multi-frame image for detecting motion status of pixel points and for adjusting if the pixel point trends to static or motion, which is then used as a foundation for further operation processing. If the pixel point trends to static status, thus, a pixel point at the same position on an adjacent frame will have similar features to the current pixel point, and can be used as relative accurate reference information, this method is called as inter-frame processing. But if the pixel point trends to motion status, thus information of a pixel point at the same position on an adjacent frame cannot be used as reference, therefore, only can a space-adjacent pixel point on the same frame be used as reference information, namely, so-called intra-frame processing.

In practical application, motion situation of each pixel point on the same frame is different with each other, in order to make up for problems caused by using single method, two processing algorithms of inter-frame and intra-frame mentioned above are combined together for obtaining the best image result. Motion adaptive algorithm weights and averages the results obtained via these two algorithms, its formula is as follows:

Pᵣₑₛᵤₗₜₛ=a×Pᵢₙₜᵣₐ−(1−a)×Pᵢₙₜₑᵣ

Wherein, Pᵣₑₛᵤₗₜ is its finally processed result, Pᵢₙₜᵣₐ is the intra-frame processed result and Pᵢₙₜₑᵣ is the inter-frame processed result. That is, the larger the motion adaptive weight value a is, the stronger the motion will be, thus it trends intra-frame processing; otherwise, if the motion adaptive weight value a is smaller, thus it trends to inter-frame processing. The motion adaptive weight value is an absolute value of a differential value between pixel points relative to two adjacent frames. Its formula is as follows:

a=P(n,i,j)−P(n−1,i,j)

Wherein, P is a luminance value of the pixel point; n is a sequential number of the image frame based on time; i is a line number of the image, on which the pixel point is located; j is a row number of the image, on which the pixel point is located.

The above explanation shows: the object processed by this image motion processing method is the pixel point, and simultaneously, by using information of local area around the processing pixel point as auxiliary information. This image processing method, because of focusing the identified object only on a micro-local area, will result in error if in comparison with global image identification method by eye. Therefore, when the image is influenced by problems such as inter-frame delay, noise and etc., especially when under situation of motion and static both existed in the image, larger identification error may occur, also with truncation effect easily occurred on edge of the area truncation.

### DETAILED EXPLANATION

This invention, focused on the problem of larger error existed in current video image motion processing method and caused by judging at a limited local area, offers a video image motion processing method introduced with global feature classification.

Another purpose of this invention is to offer a device for implementing this video image motion processing method introduced with global feature classification.

The technical idea of this invention is to utilize the global feature information of a processing video image and the local feature information of its pixel points for classifying certain local motion feature information of the pixel points, assigning correction value to each classification, and then using the correction value to correct certain local motion feature information of the pixel points, and finally to obtain more accurate local motion feature information of the pixel points.

Technical scheme of this invention is as follows:

The video image motion processing method introduced with global feature classification includes steps as follows:
A. Capturing local feature of the pixel points in the processing video image, and the said local features include the local motion features;
B. Capturing global feature of the processing video image;
C. Classifying the pixel points in the processing video image according to the said local features and the said global features obtained in the Step A and the Step B, to obtain several classifications;
D. Assigning correction parameters to the pixel point classifications obtained in the Step C;
E. Correcting the several local motion features obtained in the Step A by using the correction parameters obtained in the Step D.

The local motion features obtained in the Step A include motion adaptive weight values of the pixel points; final motion adaptive weight values of the pixel points, obtained when the local motion features corrected as said in the Step E, are the motion adaptive weight values of the pixel points.

The local motion features as said in the step A also include motion feature values between pixel point fields, which show motion status between pixel point fields, the formula for obtaining the inter-field motion feature value is as follows:

Motion_{field}=|(P(n,i−1,j)+P(n,i,+1,j)/2−P(n+1,i,j)|;

Wherein, Motion_{field} is a motion feature value between pixel point fields; P is a luminance value of the pixel point; n is a sequential number of the image field based on time; i is a line number of the image, on which the pixel point is located; j is a row number of the image, on which the pixel point is located.

The said local features obtained in the Step A also include judgment value for judging if the pixel point is an edge point or not, which is obtained via edge detection.

The said edge detection includes steps as follows:
1) Obtaining differential value of the luminance between several adjacent pixel points in the field where the processing pixel point is located, and the luminance value of the said adjacent pixel point is a definite value; differential value of the luminance between the pixel point on corresponding position within a field just in front of or at the back to the field where the processing pixel point is located and the adjacent pixel point, the luminance value of the said adjacent pixel point is a definite value;
2) Taking the maximum value from the differential values obtained in 1and comparing it with a pre-set value.

Obtaining the global features as said in the Step B includes steps as follows:
(1) Conducting statistics on the motion adaptive weight values of the selected pixel points in a processing video image, and setting a threshold as a limit, and then respectively making statistics on numbers Nₘ, of the pixel points that are higher than or higher over/equal to the threshold, and on numbers Nₛ of the pixel points that are lower than or lower than/equal to the threshold;
(2) Setting several value intervals, calculating ratio Nₘ/Nₛ, determining value interval for a ratio Nₘ/Nₛ, using a special value interval of a ratio Nₘ/Nₛ as the global feature.

The selected pixel points as said in the Step (1) of obtaining the global feature are the edge pixel points.

The classification as said in the Step C refers to classifying to obtain several classifications and to sort out the pixel points into each classification in accordance to the obtained global features, the motion adaptive weight values, the edge point judgment values and the inter-field motion feature values, of which all are used as classification basis for the processing pixel point.

The classification method said in the Step C is a decision-tree classification method.

The correction formula adopted in the correction said in the Step D is as follows:

a′=Clip(f(a,k),m,n);

Wherein, a′ is the final motion adaptive value; a is the motion adaptive weight value obtained in the Step A; k is a classification parameter in the Step D; f(a, k) is a binary function of variables a and k; Clip ( ) is a truncation function, ensuring output value within a range of [m, n].

The device for implementing the video image motion processing method introduced with global feature classification includes units as follows: a local feature capture unit, a global feature capture unit, a classification unit and a correction unit; the local feature capture unit is respectively connected with the classification unit and the correction unit; the global feature capture unit is respectively connected with the local feature capture unit and the classification unit; the classification unit is also connected with the correction unit; the said local feature capture unit is used to extract the local feature of the pixel point in the processing video image, the said local feature includes the local motion feature; the said global feature capture unit is used to extract the global feature of the processing video image; the said classification unit is used to classify the pixel points in the processing video image in accordance with results of the global feature capture unit and the local feature capture unit, and assigning the correction parameters to the classifications obtained after classifying; the correction unit utilizes the correction parameters obtained by the classification unit to correct the certain local features obtained by the local feature capture unit.

The said local feature capture unit includes a motion detection unit, the said motion detection unit outputs its results to the said classification unit; the result obtained by the motion detection unit is the motion adaptive weight value and the inter-field motion feature value of the processing pixel points.

The said local feature capture also includes an edge detection unit, the said edge detection unit outputs its results to the said global feature capture unit; the result obtained by the edge detection unit is a judgment value for judging if the processing pixel point is the edge point or not.

### Technical Achievements:

Because of introducing the global feature of the processing video image to classify the local motion features of the pixel points, and to accurately correct according to different classification, final results of the local motion features obtained by using technical scheme of this invention are more accurate. Because human eyes recognize image's effect via judging in a global and macro-view, classifying the local motion features of the pixel points via introducing the global feature can correct errors on the local motion features of the pixel points in a global view, and can avoid distortion, caused by various interferences, on motion features obtained only locally, thus improving accuracy of the local motion features of the pixel points.

When conducting the motion detection, though the most direct method for global statistics is to process all of image pixel points, that is, making statistics on motion situation of each pixel point in the image, the motion status of different pixel points in the same frame of image are all different, and a large part of the pixel points for a general continuous video is at a static status (even if human eyes feel the image in moving), and the edge pixel points in a image can further represent image motion status, that is, namely if the edge pixel point is in motion, there is motion in the image; if the edge pixel point is not in motion, there is no motion in the image. Therefore, introducing motion information of the processing video image edge pixel point for classifying, judging and processing the motion feature of the pixel point can more accurately identify motion status of an image.

Under situation of interlaced image processing during the edge detection, not only is the information of adjacent pixel point at the same field of the pixel point used as foundation, but also the information of an adjacent pixel point corresponding to the pixel point at the front field is used, that is, the motion detection shall detect motion results between adjacent fields. Because there is inter-field time gap in the original motion information obtained via inter-frame differential value (namely inter-frame motion) of the pixel point motion feature, and if change frequency of the pixel point is just the same as field frequency, it is impossible to detect the field motion (for example, (n−1) field is in black, (n) field is in white, and (n+1) filed is also in black, thus it can be judged that there is no frame motion). So, the inter-field motion detection is introduced in order to avoid such problem.

### EXPLANATION FOR FIGURES

FIG. 1 is a principal flow chart for the video image motion processing method introduced with global feature classification;

FIG. 2 is a principal flow chart for the video image motion detecting method introduced with global feature classification;

FIG. 3 is a principal drawing for obtaining the inter-field motion feature value;

FIG. 4 is a principal drawing for the edge detection;

FIG. 5 is a drawing for sorting out the pixel point classifications;

FIG. 6 is a drawing of the decision-tree classifications;

FIG. 7 is a structural drawing of the device for implementing the video image motion processing method introduced with global feature classification.

### EMBODIMENTS

The technical scheme of this invention is explained below in combination of these figures mentioned above.

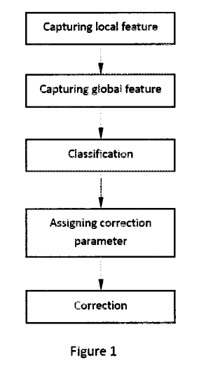

As shown in the FIG. 1, the video image motion feature processing method introduced with global feature classification includes steps as follows:
A. Capturing the local features: Capturing the local features of the pixel points in a processing video image, the local features at least include local motion feature. The local motion feature of the pixel point refers to property feature information of characterized pixel point motion status.
B. Capturing the global features: Capturing the global features of a processing video image. The global features are properties embodying the image in a macro-view, and obtained by comprehensively processing its property features (namely, the micro-view features) of the pixel points within an image.
C. Classification: Classifying the pixel points in the processing video image according to the said local features and the said global features obtained in the Step A and the Step B, to obtain several classifications. The classification is mainly to divide the several local feature values into different sections and to sort out the pixel points to different sections, thus to distribute the pixel points into different classifications. When conducting classification for the pixel points in accordance to the global features and the local features, the classifications can be overlapped, for example, the pixel points can be divided into edge pixel point and non-edge pixel point, and the edge pixel points and the non-edge pixel points can be respectively divided into motion pixel points and non-motion pixel points further.
D. Assigning the correction parameter: Assigning the correction parameter to classifications contained with the pixel points obtained in the Step C. The correction parameter here can be obtained via many ways, but generally an experience value can be adopted, that is, assigning a verified effective experience value to each classification.
E. Correction: Correcting the several local motion features obtained in the Step A by using the correction parameters obtained in the Step D, to obtain final local motion features. On the basis of actual situation, the correction can also be conducted for several local motion features.

Because the processing video image global feature is introduced for classifying the local motion features of the pixel points, and accurately correcting in accordance to different classifications, the results of the final local motion features obtained by adopting the technical scheme of this invention are more accurate. Because human eyes recognize image's effect via judging in a global and macro-view, classifying the local motion features of the pixel points via introducing the global feature can correct errors on the local motion features of the pixel points in a global view, and can avoid distortion, caused by various interferences, on the motion features obtained only locally, thus the accuracy of the local motion features of the pixel points is improved largely.

This invention will be further explained below via a video image motion detection method introduced with global feature classification (called as this motion detection method hereinafter). The processing video image signal in this Embodiment is an interlace signal, that is, one frame of an image includes two fields of image information in time sequence, the image of each field has respectively odd-line pixel information or even-line pixel information, wherein, processing focused on interlaced signal situation (such as introducing former field information in inter-field motion feature value algorithm and in edge judgment) can be omitted under situation of line-by-line signal.

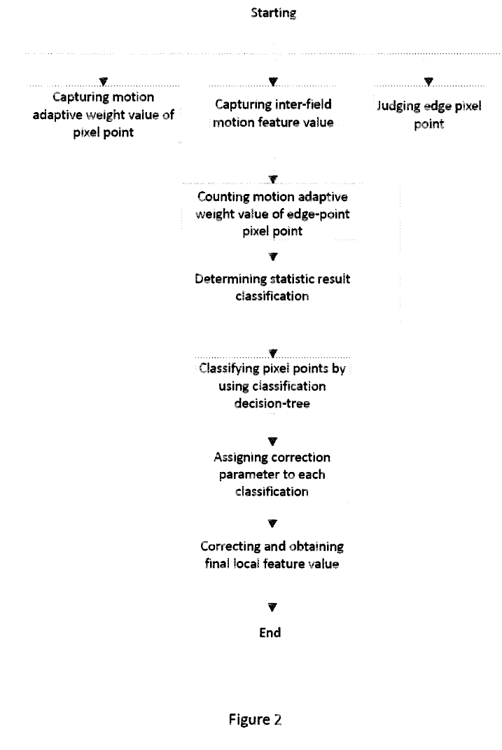

FIG. 2 reveals principals of this motion detection method. Solid-line frames in the FIG. 2 include three written frames (obtaining the motion adaptive weight value of the pixel point, obtaining the inter-field motion feature value and judging the edge pixel point), which make up a phase of obtaining the local features; dotted-line frames include two written frames (calculating the motion adaptive weight value of the edge pixel points, determining the statistic result classifications) to compose a phase for obtaining the global features.

In the phase for obtaining the local features, this motion detection method captures three local feature values: the pixel point's motion adaptive weight value, the inter-field motion feature value and the edge judgment value in the processing video image.

In the phase for obtaining the global feature, first conducting statistics of the motion adaptive weight value of the edge pixel points; then, conducting primary classification for the processing video image, in accordance with the statistic results of the edge pixel point's motion adaptive weight value and in comparison to the experience value, that is, whether the global image of the processing video image is in motion trend or in static trend.

In the classification phase, in accordance with judgment on the global image whether it is in motion trend or in static trend, and according to three local features such as the pixel point's motion adaptive value, the inter-field motion feature value and the edge judgment value said above, classifying the global pixel points to distribute each pixel point to its own classification finally, and then assigning the correction parameter to each classification belonged by the pixel point. Foundation of each classification is all the different sections divided on numerical interval on the basis of experience, and these sections are used as classification sorts, for example, a threshold can be determined for the motion adaptive weight value on the basis of experience, if the motion adaptive weight value of a pixel point is higher than this threshold, this pixel point is put into the motion pixel point's classification; the pixel points being lower than the threshold is put into the non-motion pixel point classification.

In the correction phase, by using the correction parameters obtained in the phase of the global pixel point classification, correcting the motion adaptive weight value of the processing video image pixel point to obtain motion adaptive weight value of the pixel point.

Technical measures of the steps are explained in details as follows:

### 1. The Phase for Capturing the Local Motion Features

### 1.1 The Motion Adaptive Weight Value

There are several ways for capturing the motion adaptive weight value, for example, simply using absolute value of an inter-frame differential value to obtain it, its formula is as follows:

a(n,i,j)=|P(n+1,i,j)−P(n−1,i,j)|

Wherein, a(n, I, j) is the motion adaptive weight value of the pixel points; P is a luminance value of the pixel points; n is a number of the image frame in time sequence; i is a line number of the image on which the pixel point is located; j is a row number on which the pixel point is located. For simplifying the followed data calculation, normalizing the obtained a in an equal proportion into 1, that is, limiting the obtained a values in an equal proportion into an interval of [0, 1].

### 1.2 The Inter-Field Motion Feature Value

Capturing the inter-field motion feature value, that is, obtaining the motion results between adjacent fields, its significance is that: the motion adaptive weight value obtained in 1.1 is an inter-frame motion value, but under situation of interlaced processing, original motion information exists time gap between two fields, thus, if the change frequency of the pixel point is just in accordance to field frequency, the field motion cannot be detected (for example, (n−1) field is in black, (n) field is in white, and (n+1) is also in black, it will be judged as no frame motion). For remedying this problem, it is necessary to introduce the inter-field detection, its detection foundation is the differential value relationship between P(n, i−1, j) and P(n, i+1, j), and P(n+1, i, j) (or P(n−1, i, j). Its formula is as follows:

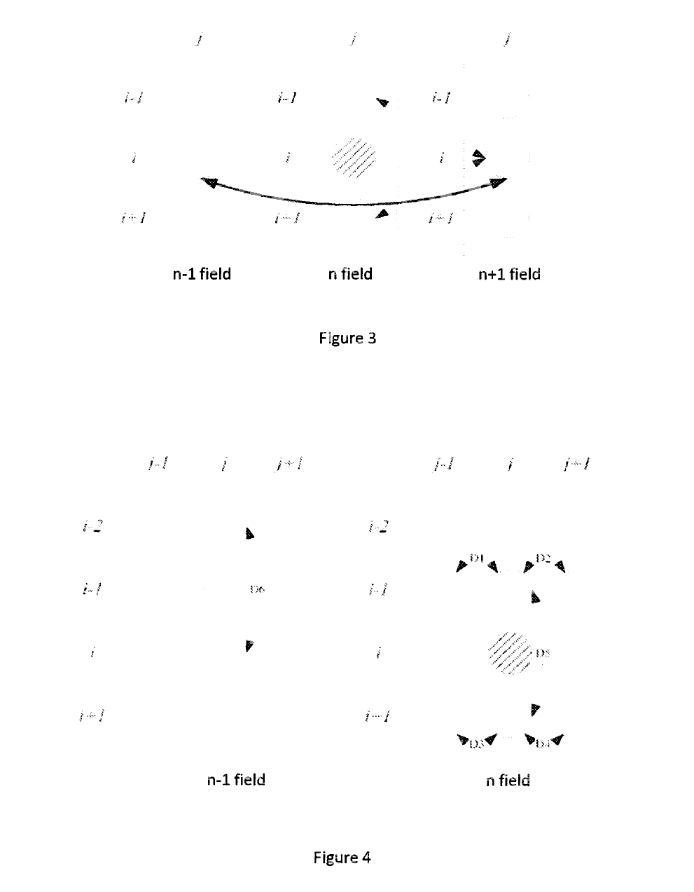

Motion_{field}=|(P(n,i−1,j)+P(n,i+1,j)/2−P(n+1,i,j)|

Wherein, Motion_{field} is the inter-field motion feature value; P is a luminance value of the pixel points; n is a number of the image field on time sequence; i is a line number of the image on which the pixel point is located; j is a row number of the image on which the pixel point is located. FIG. 3 reveals principals for obtaining the inter-field motion feature value.

### 1.3 The Edge Judgment Value

Though the most direct method for conducting statistic and judgment of the global motion situation is to process all of the pixel points on full-frame image, in a frame of image, the motion status of different pixel points are different with each other and for a common continuous video image, most pixel points are in static status, therefore, accuracy is often influenced if conducting statistics and judgment on motion status of all pixel points globally. In practical situation, edges in an image can more accurately represent the motion status of an image, so making statistics and judgment on the motion status of the edge pixel points can improve accuracy.

The edge detection includes steps as follows:
1) Obtaining the differential value of luminance between several adjacent pixel points in the field where the processing pixel point is located, the luminance value of the said adjacent pixel point is a definite value; and obtaining the differential value of luminance between the pixel point on a corresponding position within a field just in front of or at the back to the field where the processing pixel point is located and the adjacent pixel point, the luminance value of the said adjacent pixel point is a definite value;
2) Taking the maximum value from the differential values obtained in 1) and comparing it with a pre-set value.

FIG. 4 reveals principals of the edge detection in this motion detection method. Here, six differential values of luminance between pixel points are sampled in total, of which D1, D2, D3 and D4 is the differential values in horizontal direction, D5 and D6 is the differential values in vertical direction. The differential values from D1 to D6 sampled here are all the differential values between the pixel points with definite luminance, that is, because of being interlaced signal, only is the pixel point with definite luminance value within each field selected in interlacement way for the differential value. D6 (the differential value between pixel points in a former field) introduced here is an auxiliary judgment method adopted for detecting high-frequency dual-direction jumped-change edge, mainly because vertical pixel points of interlaced signals are not adjacent with each other. If there is a horizontal line in horizontal direction at the current processing pixel point, it is impossible to detect it by using interpolation of D1˜D5, so it is necessary to use D6 for auxiliary detection and judgment. Taking the maximum value from six differential values of D1˜D6, the selected maximum value is compared with a given threshold (a pre-set value), the threshold in this embodiment is 20. If the maximum value is over than the threshold, the pixel point is considered as being at the image edge, otherwise this pixel point does not belong to the image edge. The edge detection result is set as a special value and assigned to the pixel point as the edge judgment value for the followed step processing.

### 2. The Phase for Obtaining the Global Features

### 2.1 Statistics of the Motion Adaptive Weight Value of the Edge Pixel Points

For the pixel point belonging to the edge, its motion adaptive weight value is calculated into statistic data, and the pixel point at non-edge is emitted. Finally, after processing the full frame image, motion statistics result of the edge pixel can be obtained. Many statistics methods such as histogram statistics or probability density statistics can be used as a statistics method to conduct statistics for the motion adaptive weight value of the pixel points. The method adopted here is respectively to make statistics on non-motion (that is, the inter-frame motion adaptive weight value is 0) pixel point numbers Nₛ and on motion (that is, the inter-frame motion adaptive weight value is non-0) pixel point numbers Nₘ. The statistics target can also be the motion adaptive weight value of all pixel points, or the motion adaptive weight value of pixel points selected according to other rules.

### 2.2 Determining Classification for the Statistics Results

Classifying the statistics results obtained in 2.1 according to the rules listed below, to obtain different image global motion status:

Nₘ/Nₛ>p, the image trends to motion status;
Nₘ/Nₛ<p, the image trends to static status;
q≦Nₘ/Nₛ≦p, the image is either in motion status or in static status.
Wherein, p and q is respectively adjustable threshold, and p>q. In this embodiment, p and q is the selected values as follows: p=5, q=⅕. These three statuses mentioned above correspond respectively to a value, for example, 0, 1, 2 that is called as motion status, for easily processing followed. The status value obtained above is used as the global feature applying in the followed steps. Because at the time obtaining information of this frame image status, processing of this frame image has been finished simultaneously, the obtained motion status is used in the next frame processing. In order to avoid mutation of the smooth image, the value obtained in this current image and corresponded by the motion status is averaged arithmetically with the values corresponded by the motion statuses of several former frame images (commonly, three frames) to decrease the mutation in critical status.

### 3. Classification Phase: Classifying the Pixel Points by Using the Classification Decision Tree

In order to conduct different motion correction for the different status pixel points in the processing video image, in this section, the global feature, the edge judgment value, the motion adaptive weight value and the inter-field motion feature value all obtained according to the above descriptions are used as classification foundations, and excluding special description in this embodiment, these classification foundations are all divided into sorts within their value ranges and according to the given thresholds. These classification foundations will be overlapped to build a several layer's classification structure, for example, overlapping the edge judgment value and the motion adaptive weight value, and using these two values respectively as a coordinate, to build a two-dimensional system as shown in the FIG. 5, and then sorting pixels into four different quadrants, they respectively are: the edge motion pixel point C1, the non-edge motion pixel point C2, the edge non-motion pixel point C3 and the non-edge non-motion pixel points (C4 and C5).

It shall be specially explained that the non-edge non-motion pixel points are further divided here into the non-interfiled motion pixel C4 and the interfiled motion pixel C5. This is a treatment for high-frequency changing situation said above, that is, there is not motion in the inter-frame at that time, if there is an inter-field motion existed, error will occur in the judgment. In order to avoid such situation occurring, it is necessary to distinguish the situation of existed inter-field motion.

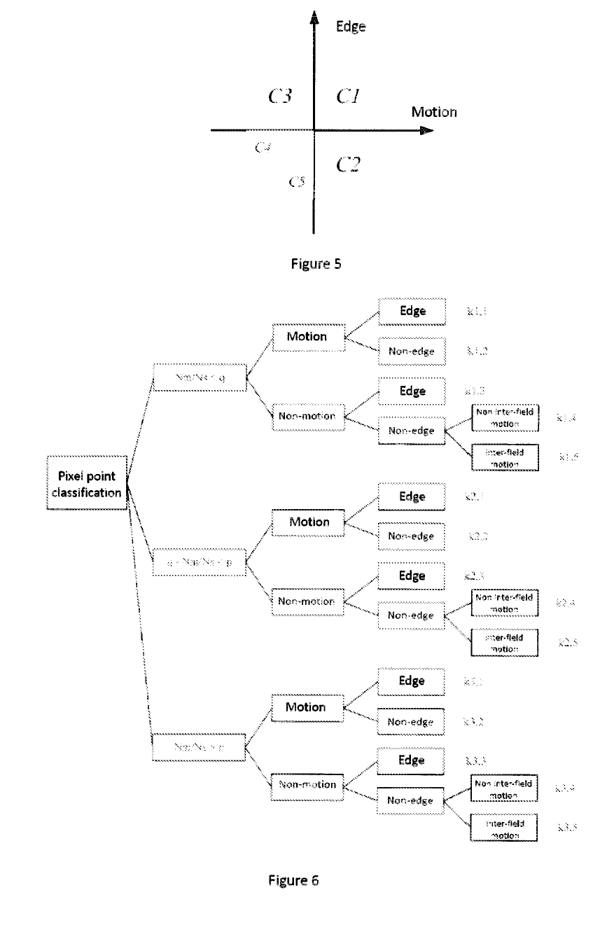

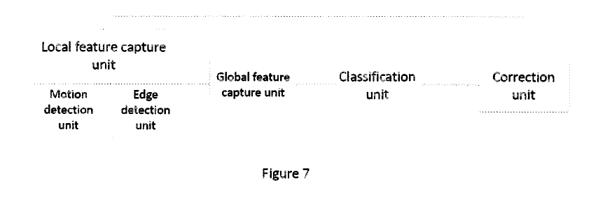

Each pixel point in the processing video image is classified. Common model classification methods include: decision tree, linear classification, Bayes classification, support vector classification and etc. Here, the decision tree classification method is adopted to classify pixel points. FIG. 6 is a decision tree classification structure finally obtained.

### 4. Assigning the Correction Parameter to Each Classification

As shown in the FIG. 6, assigning the correction parameter k to the lowest layer classification belonging to each pixel point, wherein first subscript of k respectively corresponds to first layer classifications, that is, three kinds of the global image motion statuses; second subscript respectively corresponds to the lowest layer classifications. Basic relationship among each k value is: k_{1,x}≧k_{2,x}≧k_{3,x}, ×ε{1, 2, 3, 4, 5}. The correction parameter assigned here is an experience value obtained via test. The values adopted in this embodiment are listed below in the Table:

| | X = 1 | X = 2 | X = 3 | X = 4 | X = 5 |
|---|---|---|---|---|---|
| K_{1,x} | 0.3 | 0.4 | 0 | 0 | 0.3 |
| K_{2,x} | 0.5 | 0.5 | 0 | 0 | 0.6 |
| K_{3,x} | 0.6 | 0.6 | 0.2 | 0.4 | 0.6 |

### 5. Correction Phase

On the basis of classification belonging to pixel point, respectively determining its corresponded correction parameter k; correcting, by using k value, the pixel point motion adaptive weight value obtained initially. Because of being able to more accurately correct the motion adaptive weight value obtained initially in a global view, it is possible to obtain a more accurate final motion adaptive weight value. The motion adaptive weight value is in a certain range, therefore the final motion adaptive weight value after corrected shall still be in this range, and the value higher than it is truncated. The correction formula is as follows:

a′−Clip(f(a,k),m,n);

Wherein, a′ is the final motion adaptive value; a is the motion adaptive weight value obtained in the Step A; k is the classification parameter in the Step D; f(a, k) is a binary function of the variables a and k; Clip ( ) is a truncation function, ensuring output value within the range of [m, n], that is, if higher than n, taking n as the value; if lower than m, taking m as the value. If a is normalized to 1 before, here a′ shall be within [0, 1] range.

FIG. 7 reveals a device structure for implementing the video image motion processing method introduced with global feature classification, via a sample of video image motion detection. The device for implementing the video image motion processing method introduced with global feature classification includes units as follows: a local feature capture unit, a global feature capture unit, a classification unit and a correction unit. Of which, the local feature capture unit is respectively connected with the classification unit and the correction unit; the global feature capture unit is respectively connected with the local feature capture unit and the classification unit; the classification unit is connected with the correction unit.

The local feature capture unit is used to extract the local feature of the pixel point in the processing video image, the said local feature includes the local motion feature; the global feature capture unit is used to extract the global feature of the processing video image; the classification unit is used to classify the global pixel points in the processing video image in accordance with results of the local feature capture unit, and assigning the correction parameters to the classifications obtained after classified; the correction unit utilizes the correction parameters obtained by the classification unit to correct the certain local features obtained by the local feature capture unit.

In this embodiment of the device for implementing video image motion detection method introduced with global feature classification, the local feature capture unit includes a motion detection unit, the motion detection unit receives the processing video image information, the results obtained by the motion detection unit is the processing pixel point motion adaptive weight value and the inter-field motion feature value. The result of the motion detection unit outputs to the followed classification unit.

In this embodiment of the device for implementing video image motion detection method introduced with global feature classification, the local feature capture unit also includes an edge detection unit. The edge detection unit receives the processing video image information, and the obtained result is a judgment value to judge whether the processing pixel point is an edge point or not. The result of the edge detection unit outputs to the global feature capture unit.

In this embodiment of the device for implementing video image motion detection method introduced with global feature classification, its global feature capture unit also includes an edge pixel statistics unit that is used for conducting statistics of the local motion feature of the global edge pixel point (substantially referring to the motion adaptive weight value), and using its result to classifying in the classification unit. The classification unit judges the image-belonged classification according to the statistic results of the global edge pixel point motion feature, and this classification is used as a foundation for the followed classification.

Operation process of the device for implementing video image motion detection method introduced with global feature classification is as follows:

Information of the processing video image is first processed by the local feature capture unit, to obtain the pixel-point's motion adaptive weight value, the inter-field motion feature value and the judgment value for judging whether the pixel point is an edge point or not. After the global feature capture unit receives the judgment value for judging whether the pixel point obtained by the local feature capture unit is an edge point or not, statistics on the motion adaptive weight value of the edge pixel point is conducted, and the result obtained by comparing the statistic result with a pre-set value is delivered to the classification unit. The classification unit obtains information delivered by the local feature capture unit and the global feature capture unit (the pixel-point's motion adaptive weight value, the inter-field motion feature value, the judgment value for judging whether the pixel point is an edge point or not, and the result obtained by comparing the said statistic results), distributing the processing pixel points into a definite classification according to above information, and assigning the correction parameters to these classifications. The correction unit utilizes the correction parameter obtained in the classification unit to correct the pixel-point's motion adaptive weight value obtained by the local feature capture unit, to obtain the final motion adaptive weight value. Thus, the device for implementing the video image motion detection method introduced with global feature classification has finished its operation process.

It shall be pointed out that: the substantial operation ways mentioned above in the embodiment can let the technicians in this area comprehensively understand this invention, but does not limit this invention in any ways. Therefore, though the attached reference figures and the embodiment in this specification have explained this invention in details, the technicians in this area shall understand that: this invention can still be altered or equal-substituted; but any technical schemes and any modifications not breaking away from this invention idea and technical substances shall be covered within claimed area of this invention patent.

1. A video image motion processing method introduced with global feature classification, comprising:
A. Capturing the local features of the pixel points in the processing video image, the said local features include the local motion features;
B. Capturing the global features of the processing video image;
C. Classifying the pixel points in the processing video image according to the said local features and the said global features obtained in the operation A and the operation B, to obtain several classifications;
D. Assigning the correction parameters to the classifications belonged to the pixel points and obtained in the operation C;
E. Utilizing the correction parameters obtained in the operation D to correct the several local motion features obtained in the operation A, and to obtain the final local motion features.

2. The video image motion processing method of claim 1, wherein the obtained local motion features as said in the operation A include the pixel-point's motion adaptive weight values; the local motion features for conducting correction as said in the operation E are the pixel-point's motion adaptive weight values to obtain the final motion adaptive weight values of the pixel points.

3. The video image motion processing method of claim 1, wherein the local motion features as said in the operation A also include the pixel-point's inter-field motion feature values for showing the pixel-point's inter-field motion status, the formula for obtaining the inter-field motion feature values comprises:
Motion_{field}=|(P(n,i−1,j)+P(n,i+1,j)/2−P(n+1,i,j)|

wherein Motion_{field} is the pixel-point's inter-field motion feature value; P is a luminance value of the pixel point; n is a sequential number of the image field based on time; i is a line number in the image, where the pixel point is located; j is a row number in the image, where the pixel point is located.

4. The video image motion processing method claim 2, wherein the obtained local features as said in the operation A also include a judgment values used for judging whether the pixel point obtained via edge detection of the pixel point is an edge point or not.

5. The video image motion processing method of claim 4, wherein the said edge detection includes:
1) Obtaining the luminance's differential value between several adjacent pixel points within the field where the processing pixel point is located, the said adjacent pixel-point's luminance is a definite value; the luminance's differential value between the pixel point at corresponding position of a field just in front of or at the back to the field where the processing pixel point is located, the said adjacent pixel-point's luminance is a definite value;
2) Taking the maximum value from the differential values obtained in 1), and comparing it with a pre-set value.

6. The video image motion processing method of claim 5, wherein obtaining the global feature as said in the operation B includes:
(1) Conducting statistics on the motion adaptive weight values of the selected pixel points in the processing video image, and setting a threshold as a limit, and then respectively making statistics on numbers Nₘ of the pixel points that are higher than or higher over/equal to the threshold, and on numbers Nₛ of the pixel points that are lower than or lower than/equal to the threshold;
(2) Setting several value intervals, calculating ratio Nₘ/Nₛ, determining value interval for a ratio Nₘ/Nₛ, using the special value intervals of a ratio Nₘ/Nₛ as the global features.

7. The video image motion processing method of claim 6, wherein the classification method as said in the operation C is a decision tree classification method.

8. The video image motion processing method of claim 6, wherein the selected pixel points as said in the operation (1) of obtaining the global feature are an edge pixel points.

9. The video image motion processing method of claim 8, wherein the classification method as said in the operation C is a decision tree classification method.

10. The video image motion processing method of claim 9, wherein the classification as said in the operation C refers to classifying in accordance with the obtained global features, the motion adaptive weight values, the judgment values for edge points and the inter-field motion feature values used as the classification foundations for the processing pixel point, to obtain several classification sorts and to distribute the pixel points to each classification sort.

11. The video image motion processing method of claim 9, wherein the correction formula adopted for correcting as said in the operation D comprises:
a′−Clip(f(a,k),m,n);
wherein, a′ is the final motion adaptive value; a is the motion adaptive weight value obtained in the operation A; k is the classification parameter in the operation D; f(a, k) is a binary function of variables a and k; Clip ( ) is a truncation function, ensuring output value within the range of [m, n].

12. A device for implementing the video image motion processing method introduced with global feature classification, comprising: a local feature capture unit, a global feature capture unit, a classification unit and a correction unit; the local feature capture unit is respectively connected with the classification unit and the correction unit; the global feature capture unit is respective connected with the local feature capture unit and the classification unit; the classification unit is also connected with the correction unit; the said local feature capture unit is used to extract the local features from the pixel points in the processing video image, the said local features includes local motion features; the said global feature capture unit is used to extract the global features of the processing video image; the said classification unit is used to classify the pixel points in the processing video image in accordance with results of the global feature capture unit and the local feature capture unit, and assigning the correction parameters to the classifications obtained after classified; the correction unit utilizes the correction parameters obtained by the classification unit to correct the several local features obtained by the local feature capture unit.

13. The device for implementing the video image motion processing method introduced with global feature classification, claim 12, wherein the said local feature capture unit includes a motion detection unit, the said motion detection unit outputs its results to the said classification unit; the results obtained by the motion detection unit are the motion adaptive weight values and the inter-field motion feature values of the processing pixel points.

14. The device for implementing the video image motion processing method introduced with global feature classification, claim 12 wherein the said local feature capture unit also includes an edge detection unit, the said edge detection unit outputs its results to the said global feature capture unit; the results obtained by the edge detection unit are the judgment values for judging whether the processing pixel point is an edge point or not.
